(19) United States
(12) Patent Application Publication
(10) Pub. No.: US 2014/0101775 A1
(43) Pub. Date: Apr. 10, 2014

(54) METHOD AND SYSTEM FOR DELIVERING ENCRYPTED DATA FROM A GATEWAY SERVER BASED ON A SENDER PREFERENCE

(71) Applicants: Kai Chung Cheung, Markham (CA); Christian Kamiel Peel, Aurora (CA)

(72) Inventors: Kai Chung Cheung, Markham (CA); Christian Kamiel Peel, Aurora (CA)

(21) Appl. No.: 13/647,911

(22) Filed: Oct. 9, 2012

(51) Int. Cl. H04L 29/06

(52) U.S. Cl. CPC H04L 63/06
USPC 726/27

(57) ABSTRACT

A method, system and computer program product configured for providing a recipient with an email message or data according to a delivery preference definition. According to an embodiment the delivery preference definition is defined by a sending enterprise, and comprises one or more secure delivery mechanisms. The system comprises an encrypted gateway server configured to receive the email message or data and apply, e.g. encrypt, the email according to one of the secure delivery mechanisms selected according to the delivery preference definition. The encrypted gateway server attempts delivery of the encrypted email message or data. According to an embodiment, another secure delivery mechanism may be selected and delivery attempted if the first or previous attempt does not succeed.

### FIELD OF THE INVENTION

This invention relates to secure data transmission systems, and more particularly to a method and system for delivering encrypted data from a gateway server in a network or the cloud based on a predetermined preference.

### BACKGROUND OF THE INVENTION

Email remains one of the most widely deployed communication applications on the Internet. Securing messages between a sender and a recipient can be performed in a multitude of ways.

Public Key Infrastructure or PKI cryptography is a well know technique for securing email and other digital information or data between two sources or parties, i.e. a sender and a recipient. PKI utilizes public/private key pairs for encryption and decryption. The security of PKI cryptography is based on a party's private key(s) being kept secret or confidential. In the context of the present description, a private key and public key (i.e. certificate) pair is referred to as a credential.

In addition to PKI, there are a multitude of ways in which data and/or communication channels can be secured between a sender and a recipient for providing secured email messages and data.

However, it will be appreciated that different enterprises will have different regulatory requirements in terms of acceptable security standards. In addition, business requirements or issues, such as, ease of use, deployment considerations and configurations, scalability, and/or cost, can also be overriding factors.

Accordingly, there remains a need for improvement in the art.

### BRIEF SUMMARY OF THE INVENTION

The present invention is directed to a method, computer program product and system for determining a delivery mechanism for delivering encrypted data to a recipient, wherein the delivery mechanism is based on a predetermined preference.

According to another embodiment, the present invention comprises a computer-implemented method for providing an email message to an intended recipient according to a predetermined preference definition, the computer-implemented method comprises: receiving the email message at a gateway server; configuring the gateway server according to the predetermined preference definition, wherein the predetermined preference definition comprises a plurality of secure delivery mechanisms including one or more of direct private key encryption delivery, transport layer security delivery, domain encryption delivery, direct encrypted delivery and message pickup center delivery; selecting a delivery mechanism based on the predetermined preference definition for delivering the email message from the gateway server to the intended recipient; encrypting the email message according to the selected delivery mechanism; and delivering the encrypted email message to the intended recipient.

According to another embodiment, the present invention comprises a computer program product for providing an email message to an intended recipient according to a predetermined delivery preference definition, the computer program product comprises: a computer readable storage media configured for storing instructions executable by a processor, the executable instructions comprising instructions for receiving the email message at a gateway server; configuring the gateway server according to the predetermined delivery preference definition, wherein the predetermined preference definition comprises a plurality of secure delivery mechanisms including one or more of direct private key encryption delivery, transport layer security delivery, domain encryption delivery, direct encrypted delivery and message pickup center delivery; selecting a delivery mechanism based on the predetermined preference definition for delivering the email message from the gateway server to the intended recipient; encrypting the email message according to the selected delivery mechanism; and delivering the encrypted email message to the intended recipient.

According to an embodiment, the present invention comprises a system for providing an email message to an intended recipient according to a predetermined preference definition, the system comprises: an email exchange server including an encryption component configured to encrypt the email message; an email gateway server operatively coupled to the email exchange server and including a component configured to receive the encrypted email message; the email gateway server being operatively coupled to one or more email domains; and the email gateway server including a delivery preference component, the delivery preference component being configured to deliver the encrypted email message to one of the one or more email domains according to a delivery mechanism based on a delivery preference definition.

Other aspects and features of the present invention will become apparent to those ordinarily skilled in the art upon review of the following exemplary embodiments of the invention in conjunction with the accompanying figures.

### BRIEF DESCRIPTION OF THE DRAWINGS

Reference will now be made to the accompanying drawings, which show by way of example, embodiments according to the present invention, and in which:

FIG. 1 is a block diagram showing a system configured for determining a delivery mechanism for delivering encrypted data to a recipient according to an embodiment of the present invention;

FIG. 2 is a logic flow or processing flow-diagram showing a process for defining or configuring a delivery mechanism for delivering encrypted data to a recipient based on sender preference according to an embodiment of the present invention; and

FIG. 3 is a logic flow or processing flow-diagram showing a process for delivering encrypted data to a recipient utilizing a delivery mechanism based on sender preference according to an embodiment of the present invention.

Like reference numerals indicate like elements or components in the drawings.

### DETAILED DESCRIPTION OF THE EMBODIMENTS

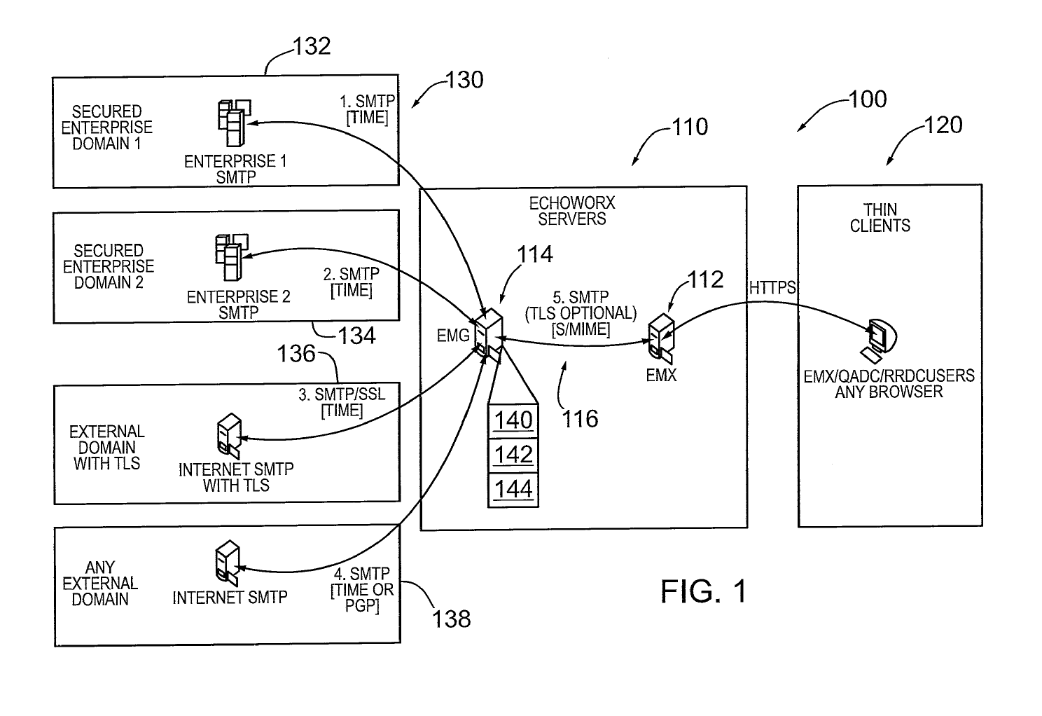

Reference is made to FIG. 1, which shows in diagrammatic form a system configured for determining a delivery mechanism for securely delivering data (e.g. an email and/or attachment) to a recipient wherein the delivery mechanism is selected or configured based on a predetermined preference, and indicated generally by reference 100.

The system 100 comprises an encryption and encrypted message platform indicated generally by reference 110, a message pickup center 120, and a plurality of email domains indicated generally by reference 130. According to an exemplary implementation, the email domains 130 comprise a first secured enterprise domain 132, a second secured enterprise domain 134, an external domain with TLS 136, and an external domain 138.

According to an embodiment and in the context of the present description, the encryption and encrypted message platform 110 comprises an encrypted message exchange (EMX) server (or servers) indicated generally by reference 112 and an encrypted mail gateway (EMG) server (or servers) indicated generally by reference 114. According to an exemplary implementation, the EMX server 112 and the EMG server 114 are linked via one or more secure communication channels or protocols indicated generally by reference 116, e.g. SMTP (TLS optional) and/or sMIME, configured through a network, e.g. LAN, WAN, VPN, the Internet (i.e. the “cloud”). The EMX server 112 is configured to provide the message pickup center 120 with access to secure communication (and related services). The EMG server 114 is configured as a gateway server for the plurality of domains (i.e. recipients) 130 of the secure communications. According to an exemplary implementation, the EMX server 112 and the EMG server 114 are based on the encrypted message platform available from Echoworx Corporation of Toronto, Canada. The EMX server 112 comprises a secure web-based portal that is configurable to allow disparate organizations to share confidential information within a secure environment.

The EMG server 114 is configured to run and function as an encrypted email gateway server 114. The particular implementation details for providing this functionality will be within the understanding of one skilled in the art. According to another aspect, the EMG server 114 is configured to perform or execute the sender preference functions according to the embodiments of the present invention. The sender preference functions comprise one or more processes and may implemented in software (or other computer executable code stored and/or executed from a computer or machine readable media) and/or hardware or programmable logic components, to perform or execute the sender preference functions according to embodiments of the present invention, as described in more detail below. According to an exemplary implementation, the EMG server 114 is configured with one or more processors, memory and non-volatile storage for the storing and executing the computer programs, software and/or computer code or logic associated with the sender preference functions and providing the functionality as described in more detail below. In FIG. 1, the processor(s), memory and non-volatile storage are indicated generally by references 140, 142 and 144, respectively.

According to an exemplary embodiment, the sender preference mechanism comprises two main processes: a definition process and an execution process.

In accordance with an embodiment, the definition process is configured for an enterprise email system. The enterprise email system is configured to manage a plurality of email domains 130 (for example, as depicted in FIG. 1). According to one aspect, the encrypted email gateway server 114 is configured according to the sender preference mechanism to utilize one or more delivery mechanisms for delivering email messages and other data to the intended recipient(s). According to another aspect, the delivery mechanisms under sender preference mechanism are configurable on an enterprise basis.

According to an embodiment, the delivery mechanisms configurable for the sender preference function comprise:

(1) Direct Private Key Encryption Delivery

(2) Transport Layer Security (TLS) Delivery

(3) Domain Encryption Delivery

(4) Direct Encrypted Delivery

(5) Message Pickup Center Delivery

According to another aspect, the sender preference function is configured to arrange the delivery mechanisms in a default order, for example, as listed above.

According to an exemplary implementation, direct private key encryption delivery comprises the following delivery mechanisms:
(1) encrypt PDF attachments of the email with a password set in the email subject in the format of [secure: password] where the password may comprise multiple words but cannot be empty. According to an alternative implementation, the password may be set as a string value in an email header. The PDF attachments are encrypted with AES encryption under the set password (and the password is stripped from the email).
(2) encrypt other types of attachments of the email with a password set in the email subject in the format of [secure: password] where the password may consist multiple words but cannot be empty. According to an alternative implementation, the password may be set as a string value in an email header. The attachments are enclosed in a ZIP file encrypted with AES encryption under the set password (and the password is stripped from the email).
(3) optionally, the body of the message may also be re-formatted as a PDF attachment, and encrypted with a password set in the email subject in the format of [secure: password] where the password may consist of multiple words but cannot be empty. According to an alternative implementation, the password may be set as a string value in an email header.
(4) the email with all the encrypted attachments will be routed for direct delivery to the user's inbox

According to an exemplary implementation, transport layer security (TLS) delivery comprises the following delivery mechanisms:

(1) Direct
routing of “clear text” email over TLS secure connection to all managed domains under an enterprise with established TLS connections
routing of “clear text” email over TLS secure connection to managed domains under all enterprise with established TLS connections

(2) Opportunistic TLS
after checking opportunistically if TLS is enabled in the destination email gateway as the primary delivery method, route “clear text” email over TLS secure connection
optionally, after the checking, the email is routed back to a SMTP host for delivery as per system configuration, with additional header added to the email to indicate TLS “opportunity”

According to an exemplary implementation, domain encryption delivery comprises the following delivery mechanisms:

(1) X.509 Certificate
encrypt emails for a specific domain by a common X.509 certificate configured for that domain. The encrypted emails are routed to the domain SMTP gateway for decryption and delivery.

(2) PGP Certificate
encrypt emails for a specific domain by a common PGP certificate configured for that domain. The encrypted emails are routed to the domain SMTP gateway for decryption and delivery.

According to an exemplary implementation, direct encrypted delivery comprises the following delivery mechanisms:

(1) Imported X.509 Certificate
encrypt emails for a specific user by a X.509 certificate imported in the Encrypted Mail Gateway for the email address of the user. The encrypted email is routed for direct delivery to the user's inbox.

(2) Imported PGP Certificate
encrypt emails for a specific user by a PGP certificate imported in the Encrypted Mail Gateway for the email address of the user. The encrypted email will be routed for direct delivery to the user's inbox.

(3) X.509 Certificate Directory Lookup
encrypt emails for a specific user by a X.509 certificate for the email address of the user obtained through a X.509 certificate directory (e.g. LDAP) lookup. The encrypted email is routed for direct delivery to the user's inbox. The directory lookup may require authentication.
multiple directories may be defined

(4) PGP Certificate Directory Lookup
encrypt emails for a specific user by a PGP certificate for the email address of the user obtained through a PGP certificate directory (e.g. LDAP) lookup. The encrypted email is routed for direct delivery to the user's inbox. The directory lookup may require authentication.
multiple directories may be defined.

(5) Echoworx X.509 Certificate Echoworx Security Cloud (ESC) Trust Service (TS) Lookup of Secure Mail user credential
encrypt emails for a specific Secure Mail user by a X.509 certificate for the email address of the user obtained through a Trust Service (TS) lookup. The encrypted email is routed for direct delivery to the user's inbox.

(6) Echoworx X.509 Certificate Echoworx Security Cloud (ESC) Trust Service (TS) of Secure Reader user credential
encrypt emails for a specific Secure Reader user by a X.509 certificate for the email address of the user obtained through a Trust Service (TS) lookup. The encrypted email is routed for direct delivery to the user's inbox.

(7) IBE/Certificate-less user credential
encrypt emails for a specific user based on an IBE encryption passphrase. The encrypted email is routed for direct delivery to the user's inbox
using the IBE encryption passphrase, the recipient will contact an IBE key server to decrypt the message

According to an exemplary implementation, message pickup center delivery comprises the following delivery mechanisms:

(1) Echoworx X.509 Certificate Echoworx Security Cloud (ESC) Trust Service (TS) Lookup of EMX user credential
encrypt emails for a specific Encrypted Mail Exchange (EMX) user by a X.509 certificate for the email address of the user obtained through a Trust Service (TS) lookup. The encrypted email will be routed for message pickup center delivery. The user will receive a notification email to log in and retrieve the email through a message pickup center.

In known manner, the encrypted email gateway server 114 is configured with computer software or code and/or hardware or programmable logic and/or a combination of software and hardware configured to perform and execute the encryption functions and operations to provide the functionality as noted above.

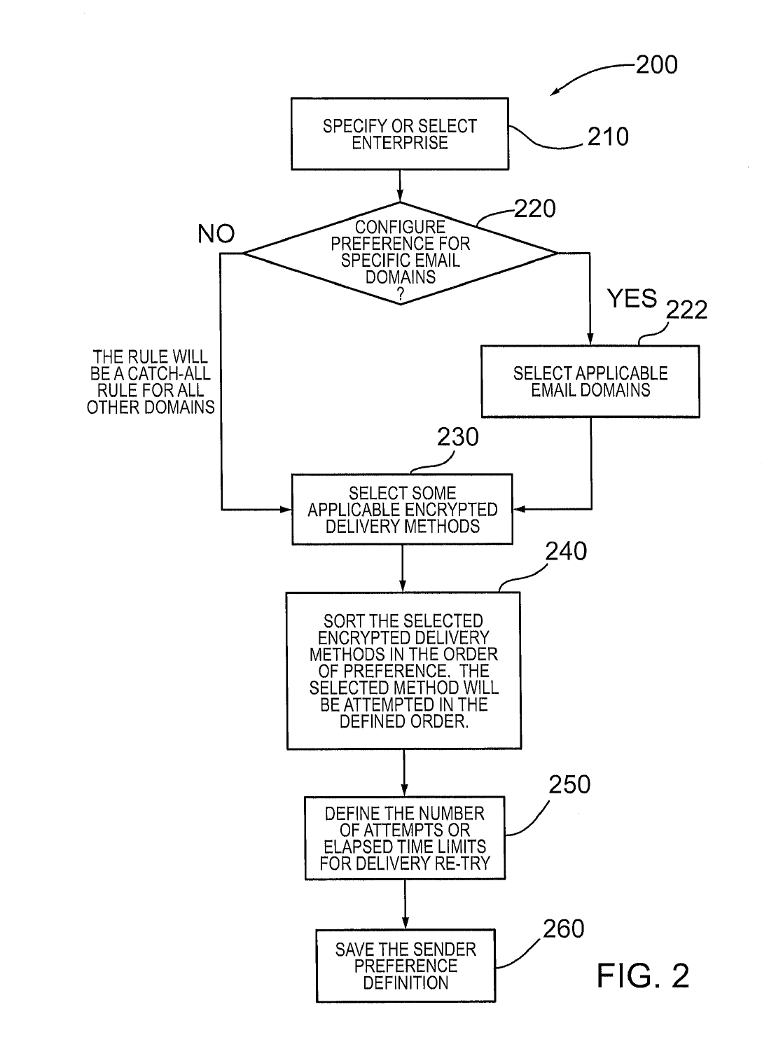

Reference is next made to FIG. 2, which shows a definition process for defining selected delivery mechanisms according to a sender preference definition in accordance with an embodiment of the present invention. The definition process is indicated generally by reference 200 and for an enterprise level implementation (e.g. an enterprise manager configured for managing email domains), comprises specifying or selecting an enterprise as indicated by reference 210. The definition process 200 comprises logic to allow a sender preference to be configured for all email domains associated with the enterprise or for specific email domains, as indicated by reference 220. If the user (i.e. the enterprise manager or an administrator) elects to specify specific email domains, then the process 200 is configured to accept the selected email domains, as indicated by reference 222. The next processing step for the definition process 200 comprises selecting or defining one or more delivery mechanisms (for example, as listed above), as indicated by reference 230. According to another aspect, the definition process 200 may comprise a process step or logic to sort or order the selected delivery mechanisms according to an order of preference, as indicated generally by reference 240 in FIG. 2. According to another aspect, the definition process 200 may comprise a process step or logic to define a number of attempts parameter or a time-limit or time-out parameter for attempting the selected delivery mechanisms before the delivery process is aborted or terminated (e.g. the email message is bounced back to the sender as being undeliverable), as indicated generally by reference 250. According to an embodiment, the default attempt parameter is set to one, and the time-out parameter is turned off or disabled. The definition process 200 is completed as indicated by reference 260 by saving the sender preference definition comprising the selected delivery mechanism(s), and the optional order of preference and/or more parameters for number of attempts and/or time-limit. The functionality associated with the definition process 200 may be implemented in computer software and/or firmware and/or code components and/or hardware and/or programmable logic components, or any combination thereof (for example, configured in the memory 142 and/or non-volatile storage 144 in the email gateway server 114), and the particular implementation details will be within the understanding of one skilled in the art.

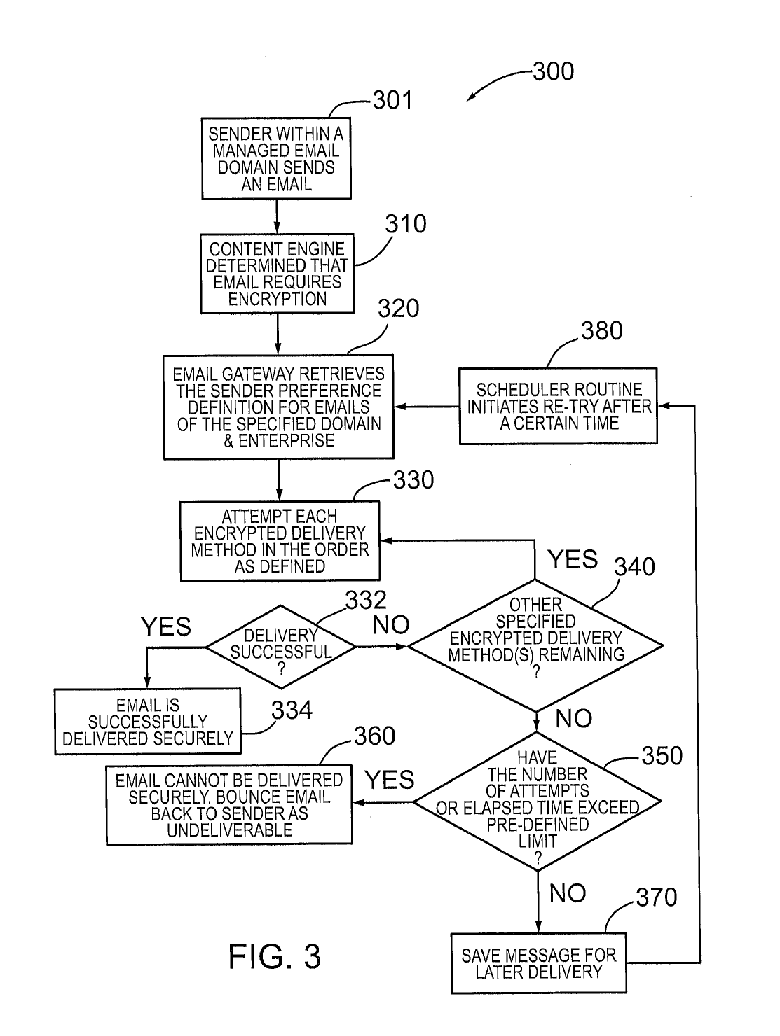

Reference is made to FIG. 3, which shows an execution process configured to execute the delivery mechanisms according to the sender preference definition, in accordance with an embodiment of the present invention and indicated generally by reference 300. The functionality associated with the execution process 300 may be implemented in computer software and/or firmware and/or code components and/or hardware and/or programmable logic components, or any combination thereof (for example, configured in the memory 142 and/or non-volatile

storage 144 in the email gateway server 114), and the particular implementation details will be within the understanding of one skilled in the art.

As shown in FIG. 3, the delivery execution process 300 commences with a user, i.e. sender, in an email domain sending an email message, as indicated by reference 301. The next step in the delivery execution process 300 comprises determining if the email message requires encryption, as indicated by reference 310. The logic or processing for this step can be embedded or part of the email exchange server for the sender. The encrypted email message is transferred or transmitted to the encrypted email gateway server 114 (FIG. 1), and the delivery execution process 300 is configured to retrieve the sender preference definition for emails originating from the specified enterprise and/or domains, as indicated generally by reference 320. The delivery execution process 300 then executes the delivery method according to the sender preference definition, as indicated by reference 330. If the sender preference definition comprises more than one delivery method, then the delivery execution process 300 executes the delivery method according to the specified order or according to a default ordering as described above. The delivery execution process 300 includes logic to determine if the email delivery was successful, as indicated by reference 332. If successful, the delivery execution process 300 ends with the email being successfully delivered, as indicated by reference 334. If the delivery execution process 300 determines that the email delivery was not successful (i.e. in step 332), then the delivery execution process includes logic to determine if there other delivery methods specified (i.e. according to the sender preference definition) or remaining to be executed, as indicated by reference 340. If yes, then the other delivery method is executed, as indicated by references 330 and 332, as described above. If there are no other delivery methods specified, then the delivery execution process 300 is configured with logic to determine if the selected delivery method has been defined with a number of attempts parameter and/or a time-limit or time-out parameter. If yes, the delivery execution process 300 is configured with logic to determine if the allowable number of attempts and/or time-out has been exceeded, as indicated by reference 350. If yes, then the delivery execution process 300 concludes that the email message is undeliverable, and bounce-back or undeliverable message or notification is generated for the sender, as indicated by reference 360. If the allowable number of attempts and/or delivery time-out has not been exceeded, then the delivery execution process 300 is configured as indicated by reference 370 to save the email message for a later delivery. According to an embodiment, the later delivery comprises a scheduler routine or function, as indicated by reference 380. According to an embodiment, the scheduler function 380 is configured to re-try or re-execute the delivery mechanism and delivery (as indicated by references 320, 330 and described above) after a pre-determined time or according to a schedule.

The operation of the system 100 is further illustrated and described in the context of the following two examples:

Example 1: a sender sam@abc.com tries to send an email through the encrypted mail gateway server (EMG) 114 (FIG. 1). The domain “abc.com” is configured with a sender preference definition, or an enterprise policy, defined as follows: (1) clear text delivery for emails from the domain under the same enterprise; and (2) message portal delivery (e.g. via a portal in the encrypted message exchange 112 in FIG. 1) for delivery to “any domain”. In a first scenario, the sender, sam@abc.com, sends an email message to recipient Robert, Robert@abc.com. According to the sender preference enterprise policy, the encrypted mail gateway server 114 is configured to deliver the email using clear text delivery (i.e. method (1)) and if successful, the message is delivered within the domain “abc.com” to Robert in clear text. In a second scenario, the sender, sam@abc.com, sends an email message to the recipient, Olsen, olsen@cbc.ca. Based on the sender preference enterprise policy, the encrypted mail gateway server 114 does not utilize clear text delivery (i.e. method (1)) because “abc.com” and “cbc.com” are domains under distinct enterprises. Instead, the encrypted mail gateway server 114 is configured to use message portal delivery (i.e. method (2)) and if successful the message is delivered to a message portal (e.g. accessible on the encrypted message exchange (EMX)) for pickup by the recipient, e.g. Olsen. It will be appreciated that according to this exemplary implementation, delivery preference for the EMG is based on the policy associated with the sender (i.e. the enterprise of the sender), e.g. the domain “abc.com”. For instance, it wouldn't matter if the recipient, Olsen, has an X.509 certificate available to the system for encrypted mail delivery, or if the recipient domain, “cbc.com”, is a known domain managed by the encrypted mail gateway server (EMG). According to this aspect, the encrypted mail gateway server is configured to the follow or apply the sender preference(s).

Example 2: a sender Sandy, sandy@bmo.com, intends to send an email message through the encrypted mail gateway server (EMG). The sender's enterprise, i.e. “bmo.com” has the following sender preference definition, or an enterprise policy: (1) TLS delivery for domains under the same enterprise (i.e. if the primary SMTP has TLS enabled, the EMG delivers messages using TLS channel encryption); and (2) encrypted mail delivery for any domains utilizing: (a) if an X.509 certificate is available for the recipient domain, then encrypt email using certificate and deliver; (b) if a PGP certificate is available for the recipient, then encrypt email with PGP certificate and deliver to the recipient; (c) if an X.509 certificate is available for the recipient, then encrypt email using certificate and deliver; or (d) if X.509 certificate is found under a Trust Service lookup, then encrypt email using the certificate and deliver. In one scenario, Sandy, sandy@bmo.com, sends an email message to Richard, richard@bmo2.com (another email domain under the same BMO), and based on the sender preference policy, the encrypted mail gateway server (EMG) is configured to attempt a TLS delivery. If successful the message is delivered from the EMG to the recipient, Richard, through TLS channel encryption. If, however, the primary server for the bmo2.com domain (e.g. the primary SMTP server) does not support TLS, the EMG is configured to attempt utilizing a certificate according to delivery methods for encrypted mail delivery for any domains (i.e. method (2)). The EMG will look for an available certificate to encrypt the message for Richard, and if found, the EMG encrypts the message using the certificate and delivers the encrypted message to Richard. If a certificate cannot be found, the email message is bounced back to the sender (e.g. Sandy) as a non-deliverable message. It will be appreciated that the message bounce back will occur even if the EMG is configured for message portal delivery because the sender preference enterprise policy does not include message portal delivery.

It will be appreciated that according to the embodiments described above the delivery mechanism(s) is selected based on the delivery preference definition for the sender domains and enterprises.

According to an embodiment, the functions, logic processing, databases, and encryption/decryption (and/or digital signing, and/or verification of signing) processes performed in the operation of the system and the associated processes and/or applications as described above may be implemented in computer software comprising one or more computer programs, objects, functions, routines, modules and/or software processes. It will be appreciated by one skilled in that the various functions, logic processing, databases, and/or the encryption/decryption processes/operations (and other operations and functions) set forth may also be realized in suitable hardware, programmable hardware or logic arrays, firmware/software stored in memory or other computer readable media and configured for one or more processing or computing devices or processors operating under stored program control, and/or firmware/software logic blocks, objects, modules or components or in combination thereof. The particular implementation details will be within the understanding of one skilled in the art.

The present invention may be embodied in other specific forms without departing from its spirit or essential characteristics. The embodiments described and disclosed are to be considered in all aspects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for providing an email message to an intended recipient according to a predetermined preference definition, said computer-implemented method comprising:
receiving the email message at a gateway server;
configuring said gateway server according to the predetermined preference definition, wherein the predetermined preference definition comprises a plurality of secure delivery mechanisms including one or more of direct private key encryption delivery, transport layer security delivery, domain encryption delivery, direct encrypted delivery and message pickup center delivery;
selecting a delivery mechanism based on the predetermined preference definition for delivering the email message from said gateway server to the intended recipient;
encrypting the email message according to said selected delivery mechanism; and
delivering said encrypted email message to the intended recipient.

2. The computer-implemented method as claimed in claim 1, wherein said predetermined preference definition is defined by an enterprise managing email domains and comprises a sender preference definition.

3. The computer-implemented method as claimed in claim 1, wherein said delivery mechanisms comprise an attachment encryption method, and said attachment encryption method being prioritized when said delivery mechanism comprise more than one delivery methods.

4. The computer-implemented method as claimed in claim 1, wherein said predetermined preference definition comprises an execution order for said secure delivery mechanisms, and further including the step of configuring said gateway server to implement said secure delivery mechanism according to said execution order.

5. The computer-implemented method as claimed in claim 1, further including the step of re-executing one of said delivery methods if there is a failure of said delivery method.

6. The computer-implemented method as claimed in claim 5, wherein said step of re-executing is repeated according to predetermined attempt number parameter.

7. The computer-implemented method as claimed in claim 2, wherein said direct private key encryption delivery comprises encrypting the email and delivering the encrypted email as an attachment.

8. The computer-implemented method as claimed in claim 2, wherein said transport layer security delivery comprises one or more of a direct routing of the email message as a clear text message over a secure transport security delivery connection, or checking opportunistically if transport security delivery is enabled for the intended recipient as a primary delivery method and routing the email message as a clear text message over a secure transport security delivery connection.

9. The computer-implemented method as claimed in claim 2, wherein said domain encryption delivery comprises one or more of X.509 certificate encryption of the email message and routing to a SMTP gateway for decryption and delivery, and PGP certificate encryption of the email message and routing to a SMTP gateway for decryption and delivery.

10. The computer-implemented method as claimed in claim 2, wherein said direct encrypted delivery comprises

11. A computer program product for providing an email message to an intended recipient according to a predetermined delivery preference definition, said computer program product comprising:
a computer readable storage media configured for storing instructions executable by a processor,
said executable instructions comprising instructions for,
receiving the email message at a gateway server;
configuring said gateway server according to the predetermined preference definition, wherein the predetermined preference definition comprises a plurality of secure delivery mechanisms including one or more of direct private key encryption delivery, transport layer security delivery, domain encryption delivery, direct encrypted delivery and message pickup center delivery;
selecting a delivery mechanism based on the predetermined preference definition for delivering the email message from said gateway server to the intended recipient;
encrypting the email message according to said selected delivery mechanism; and delivering said encrypted email message to the intended recipient.

12. The computer program product as claimed in claim 11, wherein said predetermined delivery preference definition is defined by an enterprise managing email domains and comprises a sender preference definition.

13. The computer program product as claimed in claim 12, further including the step of re-executing one of said delivery methods if there is a failure of said delivery method.

14. A system for providing an email message to an intended recipient according to a predetermined preference definition, said system comprising:
an email exchange server including an encryption component configured to encrypt the email message;
an email gateway server operatively coupled to said email exchange server and including a component configured to receive said encrypted email message;
said email gateway server being operatively coupled to one or more email domains; and
said email gateway server including a delivery preference component, said delivery preference component being configured to deliver said encrypted email message to one of said one or more email domains according to a delivery mechanism based on a delivery preference definition.

15. The system as claimed in claim 14, wherein said delivery mechanism comprises one or more of direct private key encryption delivery, transport layer security delivery, domain encryption delivery, direct encrypted delivery and message pickup center delivery.

16. The system as claimed in claim 14, further including an enterprise manager configured to manage one or more email domains, and said enterprise manager is configured to define said predetermined preference definition and said predetermined preference definition comprises a sender preference definition.

17. The system as claimed in claim 16, wherein said delivery mechanisms comprise an attachment encryption method, and said attachment encryption method being prioritized when said delivery mechanism comprise more than one delivery methods.

18. The system as claimed in claim 16, wherein said sender preference definition comprises an execution order for said secure delivery mechanisms, and said email gateway server being configured to implement said secure delivery mechanism according to said execution order.

19. The system as claimed in claim 18, wherein said email gateway server is configured to re-execute one of said delivery mechanism if there is a failure of said delivery mechanism.

20. The system as claimed in claim 19, wherein said email gateway server is configured to repeat the re-execution according to predetermined attempt number parameter.
